(19) United States
(12) Patent Application Publication
(10) Pub. No.: US 2025/0322156 A1
(43) Pub. Date: Oct. 16, 2025

(54) Artificial Intelligence-Generated Text Recognition

(71) Applicant: Michael Boucher, Lafayette, CO (US)

(72) Inventor: Michael Boucher, Lafayette, CO (US)

(21) Appl. No.: 19/017,647

(22) Filed: Jan. 11, 2025

Related U.S. Application Data
(60) Provisional application No. 63/633,738, filed on Apr. 13, 2024.

(51) Int. Cl. G06F 40/279; G06F 40/103; G06F 40/166; G06F 40/30

(52) U.S. Cl. CPC G06F 40/279; G06F 40/103; G06F 40/30; G06F 40/166

(57) ABSTRACT

Disclosed are techniques for identifying and differentiating AI-generated text within a document. The system may capture added text, compare it to known AI-generated text using word-for-word comparison and vector analysis, and may highlight identified AI-generated text. It may also include a verification process to confirm whether the AI-generated text has been adequately reviewed. A user interface may allow users to modify properties of the text, attach review notes, and record changes to text. The system may be applicable in various scenarios, such as legal briefings, academic assignments, and artificial intelligence model training.

### FIELD

This disclosure relates to the recognition of artificial intelligence (AI)-generated text.

### BACKGROUND

Multiple scenarios necessitate the differentiation between human-generated and AI-generated text within a document. For example, there have been instances where incorrect artificial intelligence (AI) produced text in legal briefs, which has led to undesirable results for the presenting lawyer, resulting in courts requiring that attorneys certify that any AI-generated text has undergone rigorous human review. Instructors also want to determine when students have used AI-generated text in papers, other assignments, or tests. Another concern is that within the field of artificial intelligence, using AI-created materials for training can lead to an adverse phenomenon known as model collapse, where the quality of models is reduced because of the inclusion of AI-generated text.

### SUMMARY

The instant application discloses, among other things, processes for collecting text added to a document and determining whether that text is AI-generated.

In one implementation, this may involve capturing text being added to a document during a copy-and-paste operation or via a user asking an application or add-in to generate text, for example.

The captured text may be compared word-for-word to known AI-generated text. Alternatively, vectors for words, phrases, sentences, paragraphs, or other sets of words may be analyzed to assess how similar various vectors are, and these embeddings may be compared to known AI-generated embeddings. The captured text or the AI-generated text may be normalized before the comparison.

If the captured text is identified as AI-generated, it may be highlighted by color or font, copied into another document, provided in a web page or other format of report, or any means of providing information to a user or another program to allow an appropriate response.

### BRIEF DESCRIPTION OF THE DRAWINGS

The present description may be better understood from the following detailed description read in light of the appended drawings, wherein:

FIG. 1 is a flow chart for AI-Generated Text Recognition, according to one implementation.

FIG. 2 is a component diagram of a computing device that may support AI-Generated Text Recognition, according to one implementation.

### DESCRIPTION

A more particular description of specific implementations of AI-Generated Text Recognition may be had by references to the embodiments shown in the drawings that form a part of this specification, in which like numerals represent like objects.

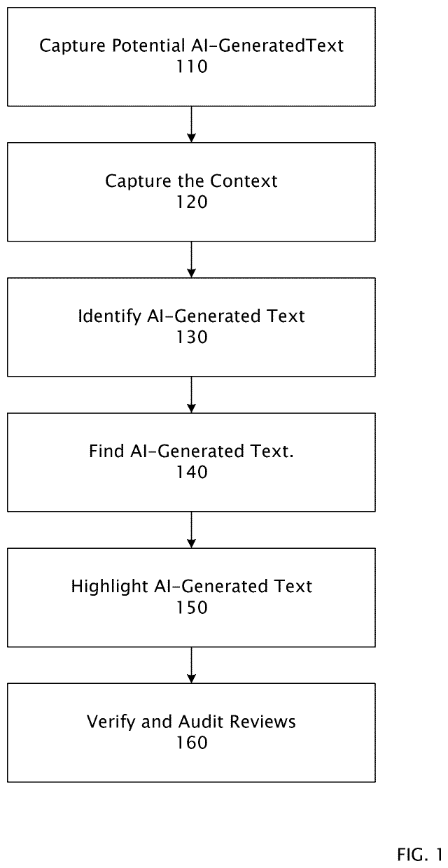

FIG. 1 is a flow chart for AI-Generated Text Recognition, according to one implementation.

Capture Potential AI-Generated Text 110 may comprise capturing copy, cut and paste, or drag and drop operations, for example. This may be done by a software plug-in, by overriding default operations in software, or by detecting mouse, keyboard, or other device's initiation to copy or paste text into a document.

Alternatively, in addition to capturing paste operations, Capture Potential AI-Generated Text 110 may comprise capturing text regions within drafting and editing programs. It may, for example, detect user-initiated requests for assistance or integrate and track the AI-provided text within the document. Such text may be provided by an AI that is part of the drafting or editing program, by an add-in or extension, or by a web service that supplies text to be used in a document.

The process of identifying potential AI-generated text may involve several steps. The first of these may be executing a Copy or Cut operation. To do this, a software plug-in may be used to detect these operations, which are frequently, but not invariably, initiated by Control-C for text within a document. Another method may involve overriding the Copy or Cut operations built into the software interacting with the document. For example, in applications such as Microsoft Word 2016, one could override the Copy method of the Range object. Additionally, the process may involve detecting any action that prompts a mouse, a keyboard, or any other human interface device to initiate an operation to copy or cut a section of text. The process may also involve detecting any action that prompts AI to insert text into a document or modify text that is already in a document.

In another implementation, text copied and pasted to the document may be marked as likely AI-generated if copied from a webpage, a portion of a webpage, or any other source known to be a common source of AI-generated text. This may be determined by an add-in to a browser, for example. For example, if text is copied from openai.com, it is likely to have been generated by AI.

In yet another implementation, text copied and pasted or dragged and dropped into a second document may be marked as likely AI-generated if the text is identified as likely AI-generated in the first document.

Upon identifying a region of text, the system may determine whether it contains material generated by an artificial intelligence system. This determination may involve comparing the text, in its original or normalized form, against a collection of known AI-generated text, which may also be in its original or normalized form. Normalization refers to transforming text into a standardized format to facilitate accurate comparisons while preserving the underlying semantic content. The purpose of normalization is to reduce variability caused by differences in formatting, casing, or terminology, which could otherwise interfere with identifying similarities.

For example, normalization may include converting all characters to lowercase, such that the word “Seattle” becomes “seattle.” Beyond simple formatting changes, normalization may also involve abstracting or generalizing specific terms into standardized representations. For instance, “Seattle” may normalize further to a generic entity such as “city” or “city1” to capture semantically equivalent terms where exact word usage may differ. This approach helps identify matches even when an AI-generated text has been altered, such as replacing specific terms with synonyms or variations.

Similarly, normalization may apply to structured text like addresses or numbers. For example, “123 Main St.” could normalize to a generic representation like “street address,” or “1,000” may normalize to “numerical value.” By generalizing these elements, the system can identify common patterns between AI-generated text and the analyzed content, even when minor changes have been introduced to obfuscate their origin.

This layered normalization process—ranging from basic formatting adjustments to semantic abstraction—enables the system to detect AI-generated content with greater robustness, reducing false negatives while minimizing the need for additional human scrutiny.

Additionally, the system may compute an embedding of the copied text, giving values that represent the meanings of words, and compare it against a collection of embeddings for texts known to be AI-generated. An embedding may represent a word or set of words as a real-valued numeric vector. Embeddings representing words, sentences, or paragraphs with similar meanings may be near each other in the vector space. For instance, the vector embedding that represents “My cat is hungry” and the vector embedding that represents “My pet feline wants to eat” may be situated very close to each other, but the vector embedding that represents “The dog wants a walk” may be much farther away. The proximity may be computed by various distance metrics, for example, the Euclidean distance or the cosine between the vectors.

For example, the system may also process text generated from within a drafting or editing program, a word processor, or a text editor. If a user requests help or the system identifies an opportunity to provide assistance, it may supply suggested text. The computer may modify the document with its suggested text or give the user a chance to accept, reject, or modify the offered text. The accepted or modified text may then be inserted into the document. The system may track where this text is added to the document, similar to how it tracks pasted text. Although this disclosure focuses on processing text, the system can also be applied to detect AI-generated content in code. For example, code generators may produce code rather than text intended for human consumption. Companies may wish to use this technology to identify which parts of a codebase are AI-generated. This could be useful, for example, in disclosing AI content in source code for copyright registration, as recommended by the Copyright Office. AI-Generated Text Recognition may also Capture the Context 120, within which potential AI-generated material appears. This may involve recording specific details about the AI and the version that generated the text, if available. Other elements that may be recorded include the prompt, prompt history, date, time, associated person or account, and the internet protocol (IP) address of the copy-and-paste operation. This information may provide a more comprehensive understanding of the context surrounding the AI-generated material.

Identify AI-Generated Text 130 may involve identifying specific text as potentially AI-generated rather than human-generated. This may involve automatically detecting AI-generated text. For example, the system may detect that the source from which a copy operation is carried out is a known source of AI-generated text, like OpenAI.com. It may also detect if the source from which a copy operation is carried out is text, which the system has previously identified as possibly having a computer origin rather than a human origin.

This may occur, for example, when a user pastes AI-generated text into a Word document and later copies that text from the Word document. In such a case, the original paste operation may mark the text as machine-generated, and the subsequent copy operation from the Word document may then recognize that this text has already been marked as AI-generated.

The system may also detect that the text on which a copy operation is being done has been marked as potentially AI-generated. This anticipates that users or the system may tag some text as AI-generated so that AI systems know not to consume such data for training purposes.

To increase certainty, algorithmic means may be used to detect whether specific text is AI-generated or human-generated. Machine learning or artificial intelligence may also be employed for this purpose. AI-Generated Text Recognition may use any combination of these techniques, either individually or collectively, in sequence or in parallel, to identify text. In addition to users tagging text as AI-generated, this approach anticipates that some Als may include watermarks in their generated text, which may further assist detection.

Further, the system may allow for manual marking of AI-generated text. A user could activate a classification user interface (UI) and operate on a selected portion of text (a unit of text) that has previously been identified. The user may start with a unit of text that has already been identified and optionally expand the unit of text to include more text or contract the unit of text to exclude text that had been included in the unit of text.

Using a checkbox, dropdown, or other UI control or widget, the user may attach, modify, or remove specific properties from the unit of text. Such properties may indicate that the unit of text is or is not AI-generated. If the unit of text is AI-generated, the user may attach further information about the specific computer text generator that created the unit of text, such as the Sep. 25, 2023 version of GPT 4.

AI-Generated Text Recognition may also detect text added by a word processor, document editor, or other application. This is similar to noting when an editor corrects a word or phrase as part of spell- or grammar-checking.

In another phase of the process, the system may aim to locate AI-generated text within a destination document. This may involve searching text in the document that aligns with one or more of the identification methods utilized in the previous steps. This process may enable a software program to apply subsequent steps to the text and its properties, thus indicating that a reviewer should either validate the text or verify that it has already been appropriately validated.

In addition to this, the system may also search for the closest matching text by using an algorithm that computes the “distance” between two text strings. This distance refers to the number of operations required to transform one string into another, which may include insertions, deletions, or substitutions of characters. By quantifying these differences, the system can assess how similar or dissimilar two text strings are, even if they are not identical.

An example of an algorithm that may be used for this task is the Levenshtein algorithm, which measures the minimum number of single-character edits (insertions, deletions, or substitutions) needed to transform one string into another. For instance, the algorithm calculates a distance of 1 between the strings “kitten” and “sitten” (a single substitution) or a distance of 3 between “kitten” and “sitting” (two substitutions and one insertion).

The Levenshtein algorithm enables the system to identify near-matches where minor variations exist, such as typographical errors, formatting changes, or intentional obfuscations. For example, it can detect that “artificial intelligence” and “artifical inteligence” are similar, despite slight differences. This capability is beneficial when analyzing AI-generated content that may have been slightly modified or rephrased to avoid exact matches.

To improve performance and scalability, the system may also employ optimizations or approximations of the Levenshtein algorithm, such as edit distance with thresholds (limiting the maximum number of allowable edits) or dynamic programming techniques that reduce computation time. Additionally, other distance-based algorithms, such as the Damerau-Levenshtein algorithm (which includes transpositions of adjacent characters) or the Hamming distance (for strings of equal length), may be used depending on the specific needs of the system.

By leveraging these distance-based algorithms, the system can effectively identify both exact and near-matching text, improving its ability to detect AI-generated content even when minor modifications or distortions are present. This approach enhances the system's robustness and reliability in identifying AI-generated material.

Another phase may concern presenting information about AI-generated text in a given document. The information may be presented in a human-readable format. This may involve Highlight AI-Generated Text 150 using various means. For example, the background color may be changed to be distinct from the surrounding text. Font characteristics, such as typeface, size, italics, bold, and underlined, may also be altered.

Comments may be added outside the document but within the drafting application, similar to the panel used by a track changes feature in a word processing application. Inline text may also be incorporated. Presentation of the information may be controlled by deactivating or activating some or all of these means. For example, the distinct background color may be activated or deactivated, the font may be returned to its original state, the Track Changes or AI panel may be turned off, or the inline drafting notes may be hidden or removed. Presentation may also use accessibility functionality to aid vision-impaired people.

Information may also be presented within an editor in the immediate context of the document or document set. This may involve highlighting text or using a Track Changes or Track AI interface. Additionally, the information may be presented outside of the immediate context of a document or document group, such as in a report.

The information may also be presented in a machine-readable format to facilitate automated processing and integration with other systems. For example, an application programming interface (API) or similar software interface may be provided, enabling external software to verify whether all AI-generated text within a document or filing has been appropriately marked and reviewed for the intended recipient. The system may support diverse user needs by offering information in both human-readable and machine-readable forms, ensuring accessibility, validation, and ease of use across both manual and automated workflows. This multi-faceted approach enhances efficiency, accuracy, and adaptability for various end-users and systems.

The instant application details a system that may include a Verify and Audit Review 160 process. A computer program may support this process, which may be standalone or embedded in other software, such as a word processor or a text processor, such as a code editor. The program may Find AI-Generated Text 140 or text from an unknown source and examine the properties associated with each instance. The program may confirm whether a given AI-generated or unknown-source text has undergone appropriate review, potentially by an authorized individual. If the review is confirmed, the program may report success. If the text has not been validated, the program may provide information about the unvalidated text.

The system may also provide a user interface (UI) that may allow a user to modify specific properties of the text, such as its validation status, the time of validation, and the individual who performed the validation. The UI may also allow users to attach review notes to specific clauses or sections of the text. For example, a user may document that a particular clause was reviewed for compliance with specific legal requirements or best practices. The user may also note any restrictions on future reuse of the text, such as whether the review was conducted specifically to comply with requirements peculiar to a specific court or jurisdiction.

The UI may also offer options for controlling scrutiny certification. It may allow users to document who, why, and when changes to the text were made and what specific changes were made. The change record may include review notes, providing context for the changes. For example, a contract clause between medical providers may have been valid under the Health Insurance Portability and Accountability Act (HIPAA) but may have become invalid after the Health Information Technology for Economic and Clinical Health (HITECH) Act was enacted.

The UI may also allow users to add documents related to a clause that do not incorporate the clause. This feature may be helpful for users who need to know whether they can or should use the clause. The UI may link attestations supplied to a court that the document has received due scrutiny, acknowledgments by a court or other authority that the scrutiny applied to the clause is sufficient for a specific purpose, and other related documents. These additional documents may be attached directly, or links to them may be supplied.

Some phases of this process may be optional, and not all implementations may require all phases. An implementation may execute phases in a sequence that does not follow the sequence described above. Implementations may also include the practice of phases with no identifiable sequence, as some phases may be conducted in parallel rather than sequentially.

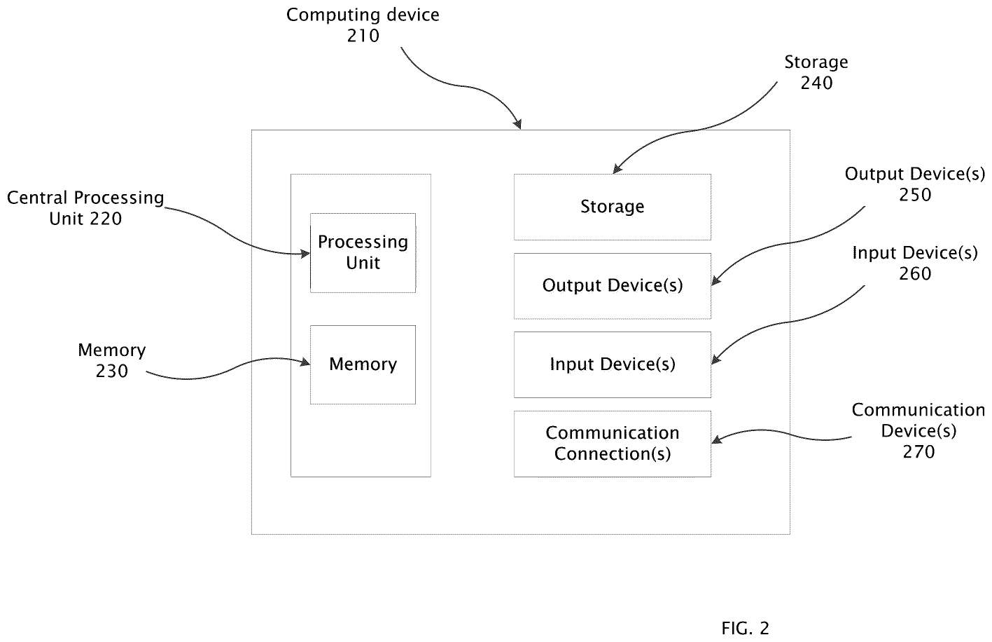

FIG. 2 is a component diagram of Computing Device 210, which may support AI-Generated Text Recognition, according to one implementation. Computing Device 210 can represent one or more computing devices, processes, or software modules, including but not limited to mobile devices. In various examples, Computing Device 210 may process calculations, execute instructions, transmit and receive digital signals, handle search queries and hypertext, and compile code suitable for mobile deployment. Computing Device 210 may be implemented as any general-purpose or specialized computer capable of performing the functions described herein, whether in software, hardware, firmware, or any combination thereof.

Computing Device 210 typically includes at least one Central Processing Unit (CPU) 220 and Memory 230 in its basic configuration. Memory 230 may include volatile memory (e.g., RAM), non-volatile memory (e.g., ROM, flash), or a combination of both, depending on the configuration of the device. Additional features may include multiple CPUs, allowing methods described herein to be executed in parallel or by any available processing unit.

Computing Device 210 may also include Storage 240, which can be removable or non-removable and implemented using magnetic, optical, or other computer-readable storage media. Examples of computer-readable storage media include RAM, ROM, EEPROM, flash memory, CD-ROM, DVDs, magnetic tapes, hard disks, or any other media suitable for storing data, program modules, or computer-readable instructions. However, computer-readable storage media do not include transient signals.

The device may further include Communications Device(s) 270 to enable communication with other devices. Communication media include wired networks, direct-wired connections, and wireless technologies such as radio frequency (RF), infrared, or acoustic signals. Communication media typically carry computer-readable instructions, data structures, or other modulated data signals where characteristics (e.g., frequency or amplitude) encode information.

Computing Device 210 may also incorporate Input Device(s) 260, such as a keyboard, mouse, microphone, scanner, touch interface, or video camera, to allow user interaction. Likewise, Output Device(s) 250, such as a display, speakers, or printers, may present information to users. These input and output devices are widely known and need not be described in detail.

In distributed implementations, storage devices containing program instructions may reside across a network. For example, a remote computer may store portions of the described processes as software, while a local or terminal computer may access, download, or execute parts of the software as needed. Alternatively, instructions may be executed cooperatively between local and remote systems. In some implementations, dedicated hardware such as digital signal processors (DSPs) or programmable logic arrays may execute all or parts of the software using conventional techniques.

The foregoing description of various implementations has been presented for illustration and description purposes. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention may be made without departing from the spirit and scope of the invention, the invention resides in the claims hereinafter appended.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show events occurring in a particular order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

1. A method for recognizing AI-generated text within a first document, comprising:
(a) capturing text by detecting an event, the event comprising a cut operation, a copy operation, a drag-and-drop operation, direct text generation, or detection of a watermark;
(b) marking the captured text as potentially AI-generated if it is determined that the text originates from a source associated with AI text generation or that the text was previously identified as AI-generated in a second document; and
(c) comparing the captured text with a stored dataset of AI-generated text or vector embeddings representing characteristics of AI-generated text to determine if the captured text is AI-generated.

2. The method of claim 1, further comprising:
providing a user interface that allows a user to manually mark text as AI-generated and input additional information associated with the AI-generated text.

3. The method of claim 2, further comprising:
generating a human-readable report summarizing any auditing and validation results, including identification of a reviewer, their credentials, and the scope of the validation; and
transmitting the human-readable report to a specified recipient or system.

4. The method of claim 1, further comprising:
normalizing the captured text to create a standardized format, wherein normalization eliminates variations in case, punctuation, and non-semantic characteristics, generating normalized captured text.

5. The method of claim 1, wherein the stored dataset of AI-generated text or vector embeddings is normalized to eliminate variations in case, punctuation, and non-semantic characteristics.

6. The method of claim 1, further comprising:
(a) applying an algorithm to the captured text to compute a vector representation of the captured text's meaning; and
(b) comparing the vector representation to a set of precomputed vector embeddings associated with known AI-generated text, wherein similarity is determined by calculating a distance metric between the vectors.

7. The method of claim 6, wherein:
the vector representations are real-valued numeric vectors, and the similarity between the vectors is assessed using a distance metric.

8. A system for recognizing AI-generated text within a first document, the system comprising:
(a) a processor; and
(b) a memory storing instructions that, when executed by the processor, cause the system to:
(i) capture text by detecting an event, the event comprising a cut operation, a copy operation, a drag-and-drop operation, direct text generation, or detection of a watermark;
(ii) mark the captured text as potentially AI-generated if it is determined that the text originates from a source associated with AI text generation or was previously identified as AI-generated in a second document; and
(iii) compare the captured text with a stored dataset of AI-generated text or vector embeddings representing characteristics of AI-generated text to determine if the captured text is AI-generated.

9. The system of claim 8, wherein the memory further stores instructions that, when executed by the processor, allow a user to manually mark text as AI-generated and input additional information associated with the AI-generated text.

10. The system of claim 8, wherein the instructions further instruct the processor to:
assess risks of model collapse if a generative model consumes the AI-generated text; or validate the AI-generated text for use within a particular jurisdiction or regulatory framework;
generating a human-readable report summarizing the auditing and validation results, including identification of the reviewer, their credentials, and the scope of the validation; and
transmitting the human-readable report to a specified recipient or system.

11. A non-transitory computer-readable storage medium storing computer-executable instructions for recognizing AI-generated text in a first document, wherein the instructions, when executed by a processor, cause the processor to:
(a) capture text by detecting an event, the event comprising a cut operation, a copy operation, a drag-and-drop operation, direct text generation, or detection of a watermark;
(b) mark the captured text as potentially AI-generated if it is determined that the text originates from a source associated with AI text generation or was previously identified as AI-generated in a second document; and
(c) compare the captured text with a stored dataset of AI-generated text or vector embeddings representing characteristics of AI-generated text to determine if the captured text is AI-generated.

12. The non-transitory computer-readable storage medium of claim 11, wherein the instructions further enable a user interface for:
manually marking text as AI-generated; and
inputting additional details regarding the AI-generated text.

13. The non-transitory computer-readable storage medium of claim 12, wherein the instructions further enable a user interface for:
generating a human-readable report summarizing the auditing and validation results, including identification of the reviewer, their credentials, and the scope of the validation; and
transmitting the human-readable report to a specified recipient or system.
